(19) United States
(12) Patent Application Publication
(10) Pub. No.: US 2009/0246108 A1
(43) Pub. Date: Oct. 1, 2009

(54) Method For Removing Ammonia From Fluid Streams

(76) Inventor: Desmond Smith, Swindon (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/145,058

(22) Filed: Jun. 24, 2008

(30) Foreign Application Priority Data
Mar. 26, 2008 (GB) GB 0805522.0

(51) Int. Cl. B01D 53/58; C10G 17/00; C02F 1/42; C02F 9/02

(52) U.S. Cl. 423/237; 208/254 R; 210/679; 210/669; 210/662

(57) ABSTRACT

A method for the removal of ammonia and its salts from fluid compositions. The method comprises contacting the fluid compositions with a scavenger on a solid support.

### CROSS REFERENCE TO RELATED APPLICATIONS

This patent application claims priority benefit under 35 U.S.C. §119(a) from Great Britain Patent Application No. GB 0805522.0 filed in the United Kingdom Intellectual Property Office on Mar. 26, 2008, the entirety of which patent application is hereby incorporated herein by reference.

### BACKGROUND OF THE INVENTION

Field of the Invention—The present invention relates to a method for reducing the levels of or substantially completely removing ammonia and ammonium ions from its salts in hydrocarbon, gas and water streams.

Modern civilization depends on burning carbonaceous materials to provide mainly electrical power and this will continue to be the case for the foreseeable future. Ammonia and its salts are natural to some fossil fuels but are also produced from nitrogen in crude oil processing in the refinery. Nitrogen, as with sulphur, is a constituent of fossil fuels. Ammonia is also present in municipal sewage waters. Ammonia is controlled by state and country specifications for the maximum level permitted in disposal waters to rivers, lakes, the sea, and to the atmosphere. The ammonia molecule is implicated in atmospheric pollution reacting with ozone/oxygen to give nitroxyl radicals contributing to air pollution.

### Origins of Nitrogen

Petroleum has an organic origin. Supporting this organic theory are the nitrogen content of oil, its optical activity, the presence of pigments of the porphyrin type, and the association of oil with marine sediments containing nitrogenous materials. Petroleum is a complex mixture of gaseous, liquid, and solid hydrocarbons. Besides the uncounted hundreds of hydrocarbons composing petroleum, there are numerous compounds of hydrogen and carbon which contain oxygen, nitrogen, phosphorus, and/or sulfur. Petroleums from different oil fields differ widely in chemical composition and in physical properties.

Some crude oils, such as those from the Bradford, Pa., sands, for example, are clear amber-colored, free-flowing fluids, while others, exemplified by La Brea, Calif., crudes, are coal black. Likewise, found in various crude oils are small but differing quantities of fatty acids, phenols, naphthenic acids, resinous compounds, asphaltenes, mercaptans, thiophenes, sulfones, sulfoxides, sulfonic acids, organic sulfides, pyridines, quinolenes, and other compounds.

Carbon-, sulfur-, and nitrogen-containing particles account for most of the anthropogenically generated particulate burden in urban areas. Considerable attention has been devoted to understanding the origin and speciation of the sulfur and nitrogen components. For example, in a report from Science, Vol. 219, No. 4584, pp. 492-493 by James E. Cooper and W. Scot Evans, Department of Geology, University of Texas, Arlington 76019 Entitled “Ammonium-Nitrogen in Green River Formation Oil Shale,” it states: “It has been assumed that all of the nitrogen in oil shale from the Green River Formation is present as organic nitrogen and that the nitrogen in spent oil shale from retorting is present in the char or coke. In fact, from 41 to 84 percent nitrogen is present as ammonium fixed within silicate minerals in five samples of raw oil shale and between 46 and 69 percent of the nitrogen is similarly fixed in two samples of spent shale. Both organic nitrogen and fixed ammonium-nitrogen are lost during retorting by the Fischer assay procedure; the loss of organic nitrogen is greater.”

Shale oil produced from the Green River Formation is very high in Nitrogen and requires upgrading before introduction into conventional refineries (see N. J. Wasilk and E. T. Robinson, in “Oil Shale, Tar Sands, and Related Materials,” H. C. Stauffer, Ed. (ACS Symposium Series 163, American Chemical Society, Washington, D.C., 1981, p. 2231). Although Forsman and Hunt (Habitat of Oil, L. G. Weeks, Ed. (American Association of Petroleum Geologists, Tulsa, 1958), p. 747) found 500 parts per million (ppm) of inorganic nitrogen in Mahogany and Papery shales from the Green River Formation in Utah, the tacit assumption generally has been that all of the Nitrogen in oil shale is present in the kerogen (see, for example, J. W. Smith, U.S. Bur. Mines Rep. Invest. 5725). After retorting, about half the Nitrogen originally present remains in the spentshale (see J. W. Smith, U.S. Bur. Mines Rep. Invest. 5932), and this Nitrogen commonly has been thought to reside in the coke rather than in the mineral fraction.

### Nitrogenous Molecules

Oil from the San Joaquin Valley (SJV) is believed to be biodegraded, a process which occurs in deposits that remain below 75 degrees C., and causes the oils to gradually increase in density (see Acidic species in Petroleum, Energy and Fuels, Vol. 15, 6, 200 by Tomcyk et al.). This article identifies amino acids as the portion of the nitrogen containing compounds in petroleum.

Hunt (Petroleum Geochemistry and Geology, W. H. Freeman and Co., San Francisco, 1979) published a review of biodegradation and indicated that there is an increase in nitrogen-containing compounds and a decrease in paraffinic compounds with increased biodegradation. The increase in nitrogen is believed to be related to the organisms themselves, and not simply the reduction in specific compound types. Another possible source of these nitrogen-rich acids could be amino acids from the cell walls of the microorganisms. As the bacteria complete their life cycle, they leave behind their amino acid-rich cell walls.

Tomcyk et al (Acidic species in Petroleum, Energy and Fuels, Vol. 15, Issue 6, 2001 by Tomcyk et al.) state that on examining the distribution of component types in the acid fraction of a SJV crude oil, they observe a broad distribution of species. Eight different component types are present in quantities ranging from 20 to 35 mol per 10,000 whole crude carbons, including O₂, O₄, S, N₂, NO, NO₂, N₂O, and N₂, O₂. The presence of oxygen atoms not only leads to the idea of carboxylic acids but also pyroles/carbonazoles/indoles for N-species, phenols for single oxygen species, and thiols for the sulfur species. Pyrollic and phenolic compounds are linked in the extracts whilst carbazole, arginine amino acids, porphyrin and pyridine nitrogenous molecules are known to be present in crude oils.

### Converting the Nitrogen in Nitrogenous Molecules to Ammonia

A high nitrogen content is undesirable in crude or natural gas as these organo-nitrogen compounds can poison the downstream catalysts in refineries, and petrochemical plants. Crude oils containing nitrogen at a level above about 0.25 percent by weight require special processing to remove the nitrogen. Only about 1 percent of the total nitrogen is recovered in distillation range of 204-327 degrees C. (400-620 degrees F.) while distilling the heavier fractions between 371-593 degrees C. (700-1000 degrees F.), yields up to 30 percent of the theoretical nitrogen value. Thus hydrotreating the distillate vacuum bottoms of the crude unit converts the high nitrogen values to ammonia. The lower distillation temperatures lead to ammonia fractionation to the top of the unit together with intermolecular bonding of nitrogen and sulfur or hydrogen sulfide molecules to thiocyantes and isothiocyanates which are then found in the overheads.

Hydrotreating is a process of catalytically stabilizing petroleum products and/or removing objectionable elements from products or feedstocks by reacting them with hydrogen. Stabilization includes converting unsaturated hydrocarbons such as olefins and diolefins (gum forming olefins involved in Diels Alder reactions) to hydrogen saturated materials such as paraffins. Objectionable elements removed in the hydrotreating process include sulfur, nitrogen, oxygen, halides, and trace metals.

Hydrotreating is applied to a variety of streams including distillation products (e.g. naphtha) and reduced crude. The hydrotreaters run below 427 degrees C. (800 degrees F.) to minimize cracking. Generally, the units run between 260-427 degrees C. (500-800 degrees F.) using a metal oxide catalyst. Hydrogen reacts with labile and susceptible species, e.g. sulfur and nitrogen, to produce sulphides and ammonia. The organic moieties, double bonds, etc. are converted to paraffinic type compounds. The catalysts used are common in this field. Those found in practice are cobalt and molybdenum oxides on alumina (most common), nickel oxide or nickel thiomolybdate, tungsten and nickel sulfides, and vanadium oxides. For high nitrogen contents, nickel-cobalt-molybdenum or nickel-molybdenum supported on alumina are used.

Other hydrotreating processes are hydrocrackers and oil hydrofiners (GOFINERS). The feeds are carefully chosen for the hydrocrackers and hydrofiners. Organic nitrogen in high concentrations can affect the common catalysts. The feedstocks are normally hydrotreated to remove sulfur and nitrogen. The catcrackers produce ammonia, hydrogen cyanide, and hydrogen sulfide at the top of the units depending on the quality of the freedstocks. The catalysts used in catcrackers can be poisoned by basic nitrogen and a host of metals.

Ammonia as discussed above is mainly produced in the hydro processor units. The amount of ammonia produced depends on the quality of the feedstocks and satisfying the hydrogen demand rate of the nitrogenous compounds, and the temperatures and pressures used in these processes. In addition to this, ammonia and amines are injected into the overheads of mainly the crude distillation tower to combat acidic gases and to control corrosion rates. There are also other units, e.g. the visbreakers and delayed coker units, which produce acidic gases with some ammonia. These overhead fluids are sent to the sour water strippers which remove hydrogen sulfide and mercaptans. Ammonia is tenacious and can reside in the water phase. Some overheads waters, which are carefully chosen but containing ammonia, are routed as make-up waters for the desalters. Finally, all waters are bulked in the waste water treatment plants and undergo the normal clean up processes mentioned above.

The “cleaned up” waters leaving water storage systems including settling ponds and lakes are tested for many constituents to meet environmental regulations. The ability to control the ammonia in the discharge waters is critical to the volume throughput of nitrogenous crude oils. As discussed above, biodegradation can increase the nitrogen value of crude oils. In this era of opportunistic crudes on the market, Athabasca crude and generally a heavier crude portfolio, nitrogen, sulfur, and acid values are on the increase. To take advantage of the economics in such a market, a refiner has to be able to refine these crude oils and manage the nitrogen to the ammonia parameter. High nitrogen is not welcome, nitrogen has to be converted to ammonia, and ammonia has to be controlled to ppb levels in discharge waters.

Many processes are known for scavenging or reducing the ammonia content of and from industrial waste water streams and municipal sewage water. In general wastewater treatment involves a host of processes including sand filtration, sedimentation, physicochemical treatment, air purging, aerobic, and anaerobic biochemical treatments.

One of these processes is described in a 2005 publication by the JGC Corporation, Yokohama, Japan, a publication wherein it is claimed that wastewater with NH₃ is fed to an Ammonia Stripper and heated up with the steam. Ammonia-rich steam is discharged from the Stripper and fed to a NH₃ Oxidative Decomposition Reactor by way of a Steam Compressor and a Reboiler. NH₃ gas is decomposed into nitrogen and water in the Reactor.

Another recent process involves the removal of contaminants including ammonia and amines from water as disclosed in U.S. Pat. No. 7,306,735, to Baggott et el. This document provides a method of removing contaminants from water which includes the steps of first providing a water feed exposed to at least one hydrocarbon or chemical process. This water feed is set in-line with a reverse osmosis system which includes an inlet, at least one reverse osmosis membrane, a permeate outlet, and a reject outlet. The reverse osmosis system then separates the water feed into a permeate and a reject which includes at least one of the contaminants. The permeate is then directed to the permeate outlet and the reject is directed to the reject outlet. The document indicates that the nitrogen-containing compounds are selected from the group consisting of ammonia and amines.

Chlorine can also be used in the removal of ammonia but it is limited to particular ranges of temperature and pH (see, for example, the Handbook of Industrial Water Conditioning, Betz Corporation, 9th edition, 1991). It is stated in this Handbook that as temperature and pH increase, the efficacy of chlorine decreases. The mono-, di-, and tri-chloramines are formed, but chlorine is not used extensively in systems containing hydrocarbons due to the detrimental formation of trihalomethanes. These organo-chlorines reduce the efficiency of chlorine as an antimicrobial agent and, if drained off to public systems, contribute to higher organo-chlorine levels in the effluents.

It is therefore an object of the present invention to provide a method to reduce or even remove ammonia from hydrocarbon, gas, or water streams. In particular, it is an object to reduce the amount of ammonia currently vented into the air from hot water streams or ammonia and its salts soluble in water streams as a by-product of various hydro-processes/catalytic crackers in the refinery. It is a further object to provide an industrial process for the removal of ammonia from fluids to a level of a few parts per billion (ppb).

### SUMMARY OF THE INVENTION

According to a first aspect of the present invention, there is provided a method for the removal of ammonia and its salts from fluid compositions, in which the fluid composition is contacted with a scavenger on a solid support. The invention may be particularly applicable to fluid compositions containing ammonia and/or its salts which derive from produced waters, refinery effluent water streams, hydrocarbon fluids, and/or gas-containing water or gaseous ammonia and/or its salts originating from petroleum hydrocarbon processes, e.g. from crude oils and its product streams, gas, refinery unit process waters, and refinery and petrochemical plant waste waters.

In one embodiment of the present invention, the method comprises: (i) selecting a transition metal from the transition metal series; (ii) preparing a macro reticular resin in a transition metal form wherein the metal is bonded to the resin and using the resulting modified resin as a column; (iii) optionally using a second, metal modified macroreticular resin column in series as a polishing column depending on the ammonia concentrations; (iv) setting up an optional macroreticular resin (A-36) scavenger column or column inserts in second column to scavenge metal ions; (v) filtration of the fluids prior to pumping into the primary macroreticular resin column; (vi) application of the filtered raw waters to the columns; (vii) monitoring of the water quality eluting from the column; (viii) switching the inlet waters to a second bank of columns depending on the quality of water eluting from the first column; (ix) applying steam to the column to remove the ammonia; (x) routing the steam and desorbed ammonia to a water cooled accumulator to condense the steam and ammonia; (xi) routing the condensed steam and ammonia to be reused as desalter makeup water or used in overheads make up water for acid control; (xii) washing the columns after cleanup with water; and (xiii) final backwashing the columns with water.

The primary macroreticular resin is modified in that it comprises transition metal ions coordinated and reacted onto the resin surface. Suitably, the transition metal ion is supplied in the form of a water-soluble salt. Suitable water-soluble salts include, but are not limited to, sulphate, nitrate, carbonate, and halide (i.e. fluoride, chloride, bromide, and iodide). The salts can contain water of crystallization. The resultant complex can be formed in situ on the column, or in batch vessels stirred and washed free of excess copper ions to pH 7 and loaded onto the column.

Suitably, the resin is packed into the form of a column so as to assist the flow-through of the fluids. Where the resin is packed into the form of a column, the raw water, or fluids or gas, is pumped through the primary column. The reaction is monitored by ammonia residuals. It is also convenient to observe the modified resin increasingly turning blue along the length of the column. When for example 85 percent of the modified resin turns blue, the raw waters, fluids, or gas can be diverted to the second bank of columns (when present). The modified resin can also be loaded into batch reactor vessels and the fluids are filled into the vessels and the ammonia is allowed to react with modified resin. After the reaction, depending on the ammonia residual in the water, the water is unloaded from the vessel via a filter unit through an outlet valve.

In cases of high starting content of ammonia, e.g. 3-5 percent ammonia, a polishing column can be used or switching to a second bank of columns may be employed. Optional techniques include a metal scavenging Amberlyst A-36 (Amberlyst is a registered trademark of Rohm and Haas Company for ion exchange resins) column to be used if the inlet water has a pH that is less than or equal to approximately 6.0.

The macroreticular resin may be a macroporous strongly acidic ion-exchange resin, suitably composed of a polymeric material. The polymeric material may be optionally cross-linked. For example, a suitable macro-reticular resin may be composed of cross-linked styrene divinylbenzene copolymers. A preferred type of such cross-linked styrene divinylbenzene copolymer macroreticular resins is Amberlyst A-15 and/or Amberlyst A-36 used for main sections in columns 1 and 2, and Amberlyst A-36 is used in an optional third column to clean up metal ions or as separate, optional top and bottom inserts in column 1 and 2 also to remove metal ions depending on the pH of the raw waters.

The transition metal ion may be one or more of the following: a Period 4 transition metal ion, a Period 5 transition metal ion, a Period 6 transition metal ion, or a Period 7 transition metal ion. Alternatively, the transition metal ion may be a Group 3 (III B), Group 4 (IV B), Group 5 (V B), Group 6 (VI B), Group 7 (VII B) Group 8 (VIII B), Group 9 (VIII B), Group 10 (VIII B), Group 11 (I B), or Group 12 (II B) transition metal ion.

Period 4 transition metal ions include: Scandium (Sc), Titanium (Ti), Vanadium (V), Chromium (Cr), Manganese (Mn), Iron (Fe), Cobalt (Co), Nickel (Ni), Copper (Cu) and Zinc (Zn). Period 5 transition metal ions include: Yttrium (Y), Zirconium (Zr), Niobium (Nb), Molybdenum (Mo), Ruthenium (Ru), Rhodium (Rh), Palladium (Pd), Silver (Ag), and Cadmium (Cd). Period 6 transition metal ions include: Lutetium (Lu), Hafnium (Hf), Tantalum (Ta), Tungsten (W), Rhenium (Re), Osmium (Os), Iridium (Ir), Platinum (Pt), and Gold (Au).

Group 3 (III B) transition metal ions include Scandium (Sc), Yttrium (Y), and Lutetium (Lu). Group 4 (IV B) transition metal ions include Titanium (Ti), Zirconium (Zr), and Hafnium (Hf). Group 5 (V B) transition metal ions include Vanadium (V) Niobium (Nb), and Tantalum (Ta). Group 6 (VI B) transition metal ions include Chromium (Cr) Molybdenum (Mo), and Tungsten (W). Group 7 (VII B) transition metal ions include Manganese (Mn) and Rhenium (Re). Group 8 (VIII B) transition metal ions include Iron (Fe), Ruthenium (Ru), and Osmium (Os). Group 9 (VIII B) transition metal ions include Cobalt (Co), Rhodium (Rh), and Iridium (Ir). Group 10 (VIII B) transition metal ions include Nickel (Ni), Palladium (Pd), and Platinum (Pt). Group 11 (I B) transition metal ions include Copper (Cu), Silver (Ag), and Gold (Au). Group 12 (II B) transition metal ions include Zinc (Zn) and Cadmium (Cd).

Preferred transition metal ions may include metal ions selected from the group consisting of Copper (Cu), Silver (Ag), Nickel (Ni), Cobalt (Co), Iron (Fe), Manganese (Mn), Molybdenum (Mo), Chromium (Cr), and Platinum (Pt). More particularly preferred transition metal ions may be Copper (Cu), Nickel (Ni), or Molybdenum (Mo).

In one embodiment of the invention, the transition metal ion is not added to the column, but rather the complex is prepared on the column, so the reaction to form the complex takes place on the column. Alternatively, the complex is prepared in batches external to the column and added as a slurry in water to the columns or optional reaction vessels or batch and pot reactors, etc. Macroreticular resins, e.g. in the form of a macroreticular resin column, are specifically designed to trap metal ions.

On flowing the liquids through the column, it is suitably allowed to initially equilibrate to allow the ammonia to react and thus permit the formation of ammonia-metal-resin complexes. After start-up, the water is continuously run through the column until process pressure conditions indicate slight increases in back pressures and differential pressures, near preset pressures, indicating the columns are operating near their optimum threshold limits of materials on the column and a reaction is occurring. The effluent from the column is monitored for ppb or ppm ammonia residuals and the 85 percent threshold cut off volume limit before switching to the second bank of columns.

The water eluted can be directed in one of two options, all depending on the variation of water pH:

Option 1: to a water clean up process, e.g. a flotation unit, or to holding ponds or lakes; and

Option 2: to the second column, a polishing-off column, and then to a metal ion clean up column.

The column containing the complexed ammonia-metal-resin can be cleaned up choosing one of a few options:

Option 1: the spent resin is steam purged and the steam-ammonia outlet is condensed in an accumulator;

Option 2: the spent resin can be sent on skids to a maintenance contractor for cleanup and reactivation for further use; and

Option 3: the spent resin on the column can be used in a similar process to scavenge naphthenic acids from desalter waters. The reaction product formed on the column in this option is a saleable commercial product.

The condensed steam and ammonia can be routed as make-up waters to the desalters and/or as overheads acid control ammonia solution.

In a laboratory scale version of the method, the resin may be prepared as a column, for example in a burette. The burette may have a physical resin bed dimension of 350 mm×10 mm, with reservoir height of 150 mm. The resin may be Amberlyst A-15 primary with metal ions clean-up resin as Amberlyst A-36.

### DETAILED DESCRIPTION OF THE EXEMPLARY EMBODIMENT

The present invention may be put into practice in a number of ways and one example will be described here in further detail.

### EXAMPLE

### Primary Modified Amberlyst A-15 Resin Method

The primary resin preparation method used, is as described below:

A glass column with a suitable sinter disc and a PTFE tap is set up on a stand. A small funnel, 40 mm diameter×50 mm stem, is placed at the top of the glass column. 36 ml of resin Amberlyst A-15 is decanted into a beaker, and distilled water is added to the resin to provide a slurry. The slurry is stirred, and the brown colored top liquid is poured off. This procedure is repeated until the water is clear, colorless, and bright. The slurry is then transferred to the column via the funnel and washed through with distilled water.

In the process of activating of the column, a 100 ml water solution of 2.5 percent hydrochloric acid is prepared and eluted down the column. The column is then washed free of residual acid to a pH of 7.

In the process of modifying the resin after acid activation, a 400 ml water solution of 1 percent copper sulphate is prepared and eluted down the column at 3 ml per minute until copper ions are detected in the eluate using an ammonia test. This column should absorb the copper ions from 360 ml of this solution. The column is then washed with distilled water until copper ions are not detected in the eluate by the ammonia test. The column is ready for use.

### Amberlyst A-36—Metal Scavenger Resin Method

The A-36 resin is prepared in a similar process to the activation of the A-15 resin above and washed after acid treatment to a pH of 7. At this stage the column is ready for use.

### Procedure

Waters having a pH of 6.5 and higher and an ammonia concentration in the range 1-1200 ppm maximum are used. The waters are first filtered if they are cloudy or dirty.

In method 1, the water is eluted down just one column (if the ammonia is less than 1200 ppm), or two macroreticular resin columns in series with ammonia greater than 1200 ppm. The first resin column removes the ammonia from 460 ml water containing 500 ppm ammonia, equivalent to about 12 column volumes using up 25 percent of the resin volume capacity. Full results are set out below. Using this method, scavenging of ammonia can be achieved on a 36 ml column using 21 column volumes and ammonia content of 1200 ppm scavenged to 7 ppb ammonia in the eluate and approximately 75 percent of the column capacity being used up.

At 85 percent breakthrough of the column and at 2 ppm ammonia in the eluate, this water can be polished off using a second column. Results show at this stage the eluate from the second column is less than 5 ppb ammonia.

In method 2, the water containing 500 ppm ammonia is eluted down one column. This resulted in higher volumes of water being eluted versus percentage column volume being used up. It is important to note that approximately 20 column volumes can be achieved in the saturation of 25 percent column volume.

In method 3, initial an pH of 6, and at 1200 ppm ammonia as ammonium salt, the ammonia was scavenged to 6 ppb at 25 percent column volume saturated and approximately 10 column volumes of water being used. The eluate was directed to the A-36 column which gave less than 40 ppb copper in the eluate.

Removal of ammonia using A-15 resin according to method 1:

85 percent Column volume will scavenge greater than 25 column volumes of 1200 ppm ammonia;

25 percent column volume, eluted solution is less than 5 ppb ammonia, using approximately 12 column volumes;

50 percent column volume equals 7 ppb ammonia, using approximately 17 column volumes;

75 percent column volume equals 10 ppb ammonia, using approximately 21 column volumes; and

85 percent column volume rises to 2 ppm ammonia, using approximately 25 column volumes.

1 column volume is 36 ml. Therefore, at 85 percent capacity, the column will scavenge 900 ml of 1200 ppm ammonia solution down to 2 ppm ammonia solution.

If the column, after saturation with ammonia, is used to clean up naphthenic acids from desalter waters, the byproduct trapped on the column contains the complexed naphthenic acids, which can be stored in tanks for eventual sales to chemical companies manufacturing wood preservatives, fungicides, and copper based biocides. The washings from the columns are routed to the slop oil tanks for eventual cleanup.

This technique holds great potential as an industrial water clean up process for upstream crude oil and downstream refinery processes. References to naphthenic acid include naphthenate and vice versa unless the context clearly specifies otherwise.

Water compositions, which can be treated by this method of the invention, include waters containing residual crude oil, or partially purified crude oil, or an oil or substance obtained from crude oil following subsequent crude oil distillation, for example petroleum, kerosene, or paraffin. The method may be practiced on processes of effluent water obtained from crude oil processes directly, or from sludges, oil deposits, oil emulsions, bitumens, asphalts, or tars which have been processed to separate off dirty waters. The process covers such fluids containing carboxylic acids and/or amines/ammonia as received from crude oil production, drilling, completion, and oil refining, petrochemical, and municipal sewage processes.

The water may be a raw extract from a crude oil ground reservoir or from an oil-emulsion following purification and extraction, or it may be present in a refinery effluent stream, from such processes giving contamination by a distillate, fraction, or other liquid residue from a process unit. The water may contain a hydrocarbon composition dispersed in the water and subjected to the applied procedure. Methods of the invention are therefore applicable to the cleanup of wastewater from a refinery, sludges from API pits, water clarification units where the hydrocarbon containing compositions are dispersed and/or emulsified in the water, and the ammonia are extractable on the resin columns.

Preparation of the Water in the Process stream or lake waters may include appropriate steps to remove particulate and/or solid matter, excess hydrocarbons and other impurities. The dirty water preparation step for removal of excessive solids may involve gravity settling, decanting off the waters, filtration settling, or centrifuging off the solids.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method for the removal of ammonia and its salts from fluid compositions, said method comprising:
contacting said fluid compositions with a scavenger on a solid support.

2. A method as defined in claim 1, wherein the fluid compositions comprise:
produced water, a refinery effluent water stream, a hydrocarbon fluid stream, refinery unit process waters, refinery and petrochemical plant waste waters, or a sewage water stream.

3. A method as defined in claim 1, wherein the solid support comprises:
a resin.

4. A method as defined in claim 3, wherein the resin comprises:
a macro reticular resin.

5. A method as defined in claim 3, wherein the resin comprises:
an acidic ion-exchange resin.

6. A method as defined in claim 5, wherein the resin comprises:
a polymeric material which may optionally be cross-linked.

7. A method as defined in claim 5, wherein the resin comprises:
a cross linked styrene divinylbenzene copolymer.

8. A method as defined in claim 7, wherein the resin comprises:
Amberlyst A-15 or Amberlyst A-36.

9. A method as defined in claim 1, wherein the scavenger comprises:
a transition metal ion.

10. A method as defined in claim 9, wherein the transition metal is selected from a Period 4, 5, 6, or 7 transitional metal ion.

11. A method as defined in claim 10, wherein the transition metal is selected from Copper (Cu), Nickel (Ni), Cobalt (Co), Iron (Fe), Manganese (Mn), Chromium (Cr), and Molybdenum (Mo).

12. A method as defined in claim 11, wherein the transition metal comprises copper.

13. A method for the removal of ammonia and its salts from fluid compositions as defined in claim 1, said method comprising:
(i) selecting a transition metal from the transition metal series;
(ii) preparing a macro reticular resin in a transition metal form wherein the metal is bonded to the resin and using the resulting modified resin as a column;
(iii) optionally using a second, metal modified macroreticular resin column in series as a polishing column depending on the ammonia concentrations;
(iv) setting up an optional macroreticular resin scavenger column or column inserts in second column to scavenge metal ions;
(v) filtration of the waters prior to pumping into the primary macroreticular resin column;
(vi) application of the filtered raw waters to the columns;
(vii) monitoring of the water quality eluting from the column;
(viii) switching the inlet waters to a second bank of columns depending on the quality of water eluting from the first column;
(ix) applying steam to the column to remove the ammonia;
(x) routing the steam and desorbed ammonia to a water cooled accumulator to condense the steam and ammonia;
(xi) routing the condensed steam and ammonia to be reused as desalter makeup water or used in overheads make up water for acid control;
(xii) washing the columns after cleanup with water; and
(xiii) final backwashing the columns with water.

14. A method as defined in claim 13, wherein the primary column, saturated with ammonia, is used for scavenging naphthenic acids from refinery process and drain waters including the desalters and tank drainage waters.

15. A method as defined in claim 13, wherein the spent resin is sent to a contractor for cleanup and reactivation.

16. A method as defined in claim 13, wherein the raw water composition comprises:
waters from upstream crude oil production, drilling return waters, produced waters stored in lakes, refinery effluent waters, and industrial processes producing nitrogen containing waters.

17. A method as defined in claim 1, additionally comprising:
a first step of separating ammonia and ammonium salts from the water composition, said first step being carried out by separating excessive solids from the water by any suitable means such as centrifuging, filtration, and settling.

18. A method as defined in claim 13, wherein the primary columns and the optional scavenger column are activated in the acid form by washing with 5 percent hydrochloric acid and washing off the excess acid from the columns to approximately pH 7 with water.

19. A method as defined in claim 18, wherein the primary acid activated columns are prepared by eluting a 1-5 percent water solution of copper sulphate, and washing the column until the water washes do not contain copper by the ammonia test.

20. A method as defined in claim 19, wherein the preferred concentration of copper sulphate is approximately 1 percent in water.

21. A method as defined in claim 1, wherein the concentration of ammonia and ammonium ions is reduced to a level of about 15 ppb or less.

22. A method for the removal of ammonia and its salts from a fluid composition, the method comprising:
providing a transition metal ion scavenger that is bonded onto a first column comprising a solid support made of a macro reticular resin material; and
contacting said fluid composition with the transition metal ion scavenger on the first column comprising the solid support made of macro reticular resin material.

23. A method as defined in claim 22, additionally comprising:
evaluating the ammonia concentration in the fluid composition; and
depending upon the ammonia concentration, optionally using a second, metal modified macroreticular resin column in series as a polishing column.
